(19) United States
(12) Patent Application Publication
(10) Pub. No.: US 2013/0025421 A1
(43) Pub. Date: Jan. 31, 2013

(54) FOOD PREPARATION DEVICE

(71) Applicants: CONSTANTINO TRIMARCHI, Orlando, FL (US); Armando Di Francesco, Orlando, FL (US)

(72) Inventors: CONSTANTINO TRIMARCHI, Orlando, FL (US); Armando Di Francesco, Orlando, FL (US)

(21) Appl. No.: 13/551,304

(22) Filed: Jul. 17, 2012

Related U.S. Application Data
(60) Provisional application No. 61/512,187, filed on Jul. 27, 2011.

(51) Int. Cl. A47J 43/00; B26D 7/01

(52) U.S. Cl. 83/30; 83/821

(57) ABSTRACT

A food preparation device includes an elongated, generally tubular rectangular main body having a top opening, a bottom opening, and a plurality of elongated grooves extending vertically along the main body. The device also includes a cap and base section for being removably positioned onto the main body, each of the cap and base sections including a plurality of openings for receiving and positioning a plurality of skewers.

### CROSS-REFERENCE TO RELATED APPLICATIONS

This application claims the benefit of U.S. application Ser. No. 61,512,187 filed on 27 Jul., 2011, the contents of which are incorporated herein by reference.

### TECHNICAL FIELD

The present invention relates generally to a device for preparing food prior grilling, and more particularly to a device for arranging food to be evenly cut and speared via a skewer.

### BACKGROUND

The statements in this section merely provide background information related to the present disclosure and may not constitute prior art.

Kebab style meals utilize an elongated rod called a brochette as a skewer for impaling and subsequently grilling a plurality of small sized food items. The brochette is typically constructed from either a bamboo stick or steel rod that can withstand the heat of a cooking grill in order to securely position the food items onto the grilling surface in a manner that prevents the items from falling into the fire.

As any cook will attest, one of the most difficult and time consuming aspects of preparing kebab style meals results from the need to cut each of the food items into small, evenly sized pieces. To this end, the food items which typically range from chicken and steak to vegetables and seafood must be cut into square pieces having overall sizes that are as identical as possible, in order to be evenly distributed on the skewer. Cutting pieces of uneven size may affect the final grilled product as bigger pieces will take longer to cook than smaller ones, thereby affecting the final result and food quality. Moreover, when the food items are not cut evenly, the impaling maneuver is difficult to achieve, as it is best for each food item to be impaled in the centermost area to avoid the skewer from being disarmed while it is grilled.

Although there are known utensils for preparing skewers in the prior none of these devices combine the features of the food preparation device disclosed herein. Accordingly, there remains a need for a food preparation device capable of arranging food items in a precise manner to be evenly cut and then impaled onto a brochette.

### SUMMARY OF THE INVENTION

The present invention is directed to a food preparation device for uniformly positioning food items to be cut and skewered. The device can include an elongated, generally rectangular main body having a top opening, a bottom opening, and a plurality of elongated grooves extending vertically along each of the side walls of the main body. The device can also include a cap and base section for being removably positioned onto the main body. The cap section can include a plurality of evenly spaced openings for inserting a skewer into the main body, and the base section can include a plurality of evenly spaced divots for receiving and positioning each of the received skewers in a vertical orientation.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is an exploded parts view of the food preparation device that is useful for understanding the inventive concepts disclosed herein.

FIG. 2 is a perspective view of the food preparation device in accordance with one embodiment of the invention.

FIG. 3a is a perspective view of the main body of the food preparation device in operation, and in accordance with one embodiment of the invention.

FIG. 3b is a perspective view of the food preparation device in operation in accordance with the one embodiment of the invention.

FIG. 3c is a perspective view of the base section of the food preparation device in operation, and in accordance with the one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

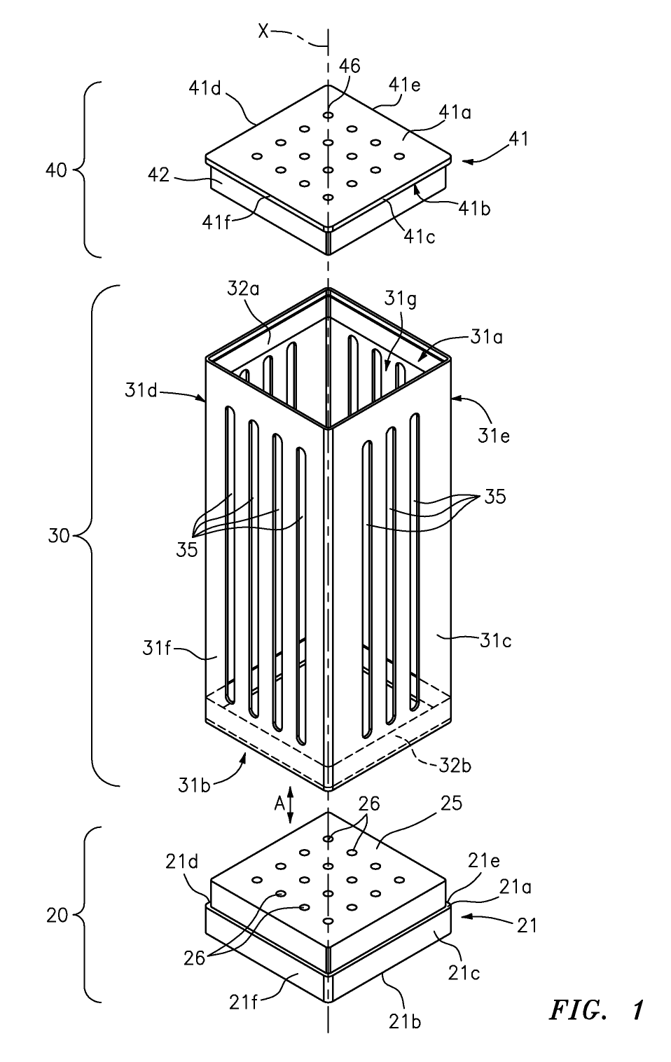

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

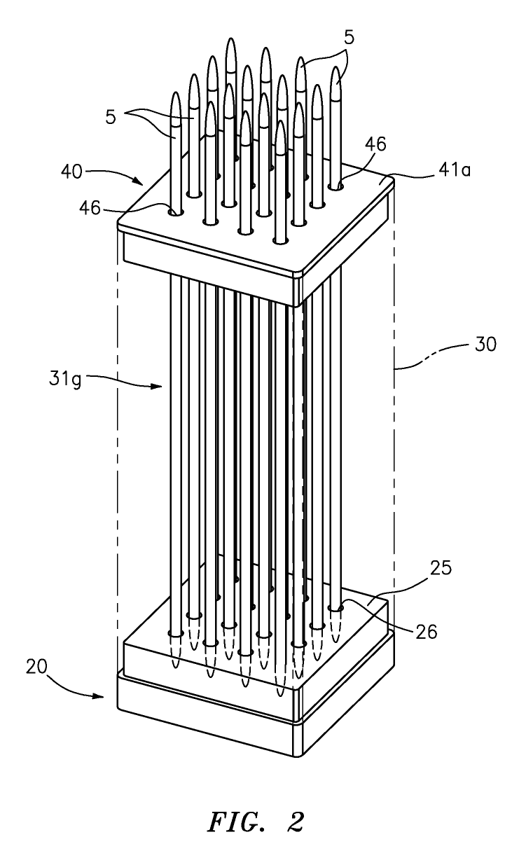

FIGS. 1 and 2 illustrate one embodiment of a food preparation device 10 capable of uniformly positioning food items to be cut and skewered. As shown, the device 10 can include a base section 20, a main body 30 and a cap section 40.

The base section 20 can include a generally square or rectangular member 21 having a top surface 21a, a flat bottom surface 21b, and a plurality of side sections 21c, 21d, 21e and 21f. The base section can act as the bottom of the assembled device 10 in order to allow the device to stand in an upright orientation.

A skewer receiver 25 can extend upward from the base member and will include a generally square or rectangular shape having plurality of horizontally recessed and upward radiating edges corresponding to sides 21c-21f. As shown, the top surface of the skewer receiver 25a can include a plurality of evenly spaced divots/openings 26 in order to uniformly receive a plurality of skewers, as will be described below in detail. To this end, the skewer receiver 25 will include a smaller dimension than the base member 21 in order to be removably inserted into the bottom of the main body 30.

In one preferred embodiment, both the skewer receiver 25 and the base member 21 will be constructed from a sturdy material such as stainless steel, for example. However, any number of other food grade materials such as plastic, wood, bamboo, steel and fiberglass, for example.

The main body 30 can include an elongated, generally rectangular tube-like member having a top opening 31a, a bottom opening 31b and a plurality of side walls 31c, 31d, 31e and 31f defining a hollow central portion 31g. An upper lip 32a and lower lip 32b can be disposed along the inner periphery of the openings 31a and 31b, respectively. Lips 32a and 32b can include an internal protrusion having an overall dimension that approximates the outer dimension of the cap protrusion 42 and the skewer receiver 25, respectively. To this end, the cap protrusion 42 and receiver 25 can be inserted into the main body via openings 31a and 31b, and retained in place via the lips 32a and 32b, respectively. Construction methodologies for sizing and constructing articles to be joined together in a compression fitting manner are well and truly known in the art.

Each of the side walls 31c-31f of the main body 30 can include a plurality of elongated longitudinal parallel (i.e., X axis) and equally spaced grooves/openings 35. These grooves 35 act to create passages for accessing the center portion 31g of the main body. As shown, the grooves 35 are bounded on each of the side sections by the lips 32a and 32b.

In one preferred embodiment, the body 30 can be constructed from stainless steel, however any number of other food grade materials such as plastic, wood, bamboo, steel and fiberglass, for example, can also be utilized.

The cap 40 can include a generally square or rectangular member 41 having a top surface 41a, a flat bottom surface 41b, and a plurality of side sections 41c, 41d, 41e and 41f. The cap can act as the uppermost portion of the assembled device 10 in order to retain any food items within the main body.

A cap protrusion 42 can extend downward from the cap member and will include a generally square or rectangular shape having plurality of recessed and downward radiating edges corresponding to sides 41c-41f. To this end, the cap protrusion 42 will include a smaller dimension than the cap member 41 in order to be removably inserted into the top portion of the main body 31a, and to interact with the upper lip 32a.

As shown, the cap 40 can include a plurality of evenly spaced openings 46 extending from the top surface 41a, through the cap protrusion 42. When the cap 40 is secured to the main body 30, the openings 46 will create a series of pathways for accessing the interior space of the main body 31g. As will be described below, each of the openings 46 will correspond in size and location to each of the plurality of divots 26 in order to receive and align inserted skewers.

As shown best in FIG. 2, when both the cap 40 and the base section 20 are secured to the main body 30, each of the plurality of openings 26 and 46 will be aligned along the X axis in order to uniformly receive and position a plurality of skewers 5 through the interior space of the main body 31g. To this end, the openings 26 of the skewer receiver can receive the skewers and position the same in an upright manner.

In one preferred embodiment, the cap member 41 and the cap protrusion 42 will be constructed from a sturdy material such as stainless steel, for example. However, any number of other food grade materials such as plastic, wood, bamboo, steel and fiberglass, for example can also be utilized herein.

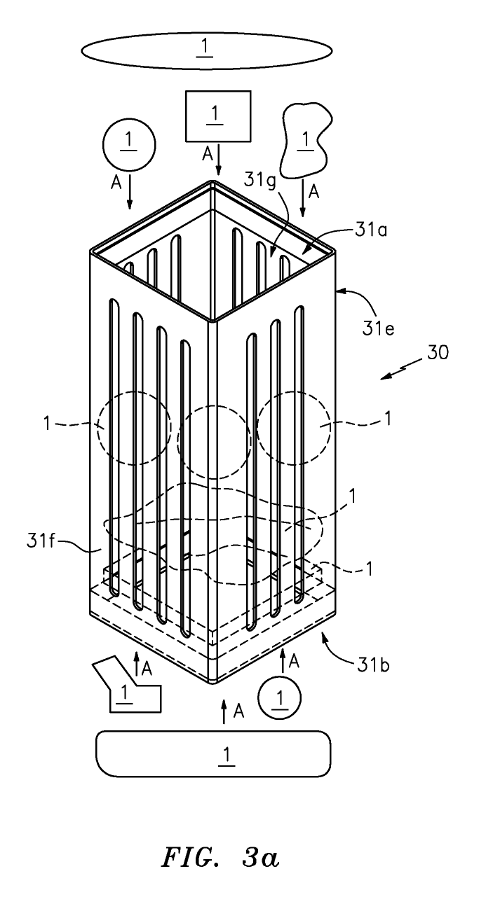

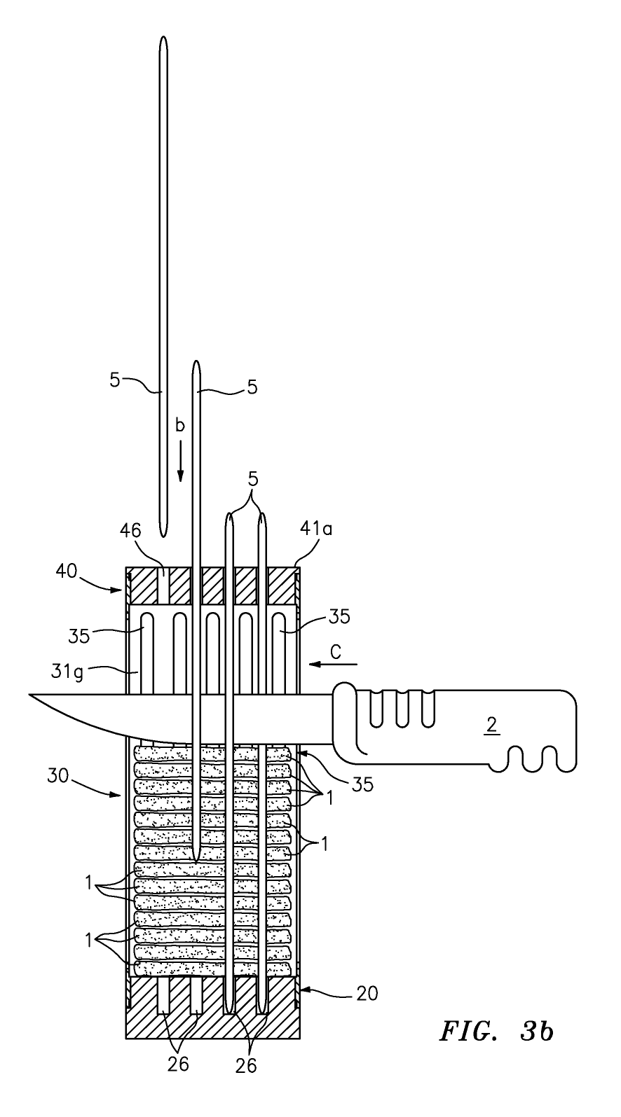

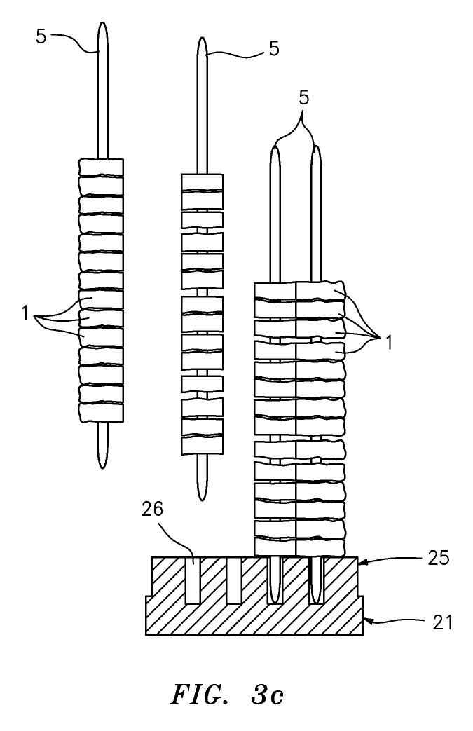

FIGS. 3a-3c pictorially illustrate a method of utilizing the food preparation device, in accordance with one embodiment.

As shown in FIG. 3a, a plurality of food items 1 of varying shapes, types and sizes can be deposited, see arrow a, into the interior space of the main body 31g via one or both of the openings 31a and 31b.

As shown in FIG. 3b, upon loading the main body with food items 1, the base section 20 and the cap 40 can be secured to the main body 30 as described above, and the device can rest in an upright orientation with the food items 1 securely located within the interior space 31g of the main body. When so positioned, a plurality of skewers 5 can be inserted downward, see arrow b, through the openings 46 of the cap and through the food items 1 until resting within the openings 26 of the base section. When so secured, a knife 2, or other such cutting instrument can be inserted, see arrow c, through the grooves 35 until exiting the grooves 35 of the opposing side of the main body (e.g., sides 31c and 31d, respectively), and then making a cutting motion downward (see arrow b) until slicing through each of the food items 1. This cutting procedure can then be repeated with the other pair of opposing grooves 35 (e.g., sides 31e and 31f) until each of the food items have been cut into squares of approximately identical sizes.

Finally, as shown in FIG. 3c, once the food 1 has been evenly cut and skewered, the cap section 40 and the main body 30 can be removed, and the base section can act to position the full skewers in an upright manner. These skewers can then be individually removed for grilling.

As described herein, the food preparation device 10 simplifies the production of brochettes allowing the user to make them, thereby simplifying the process of chopping the ingredients and impaling them onto the rods of the skewer.

Although illustrated as including a generally rectangular shape and corresponding components, those of skill in the art will recognize that the device 10 can be constructed from any number of different materials and can take any number of conventional shapes.

As described herein, one or more elements of the food preparation device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individual elements such as the main body 30, the cap 40 and/or the base section 20, including all sub components, for example, may be formed together as one continuous element, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A food preparation device for receiving food items to be evenly cut and speared via skewers, said device comprising:
an elongated main body that includes
a plurality of opposing sides defining a generally rectangular hollow interior space, said main body further including a top opening and a bottom opening that are each in communication with the hollow interior space,
a plurality of elongated grooves disposed within each of the plurality of opposing sides, each of said grooves providing a pathway for accessing the interior space, and configured to receive a cutting instrument;
a base section that includes
a flat bottom surface and a generally rectangular protruding upper surface, said upper surface being configured to be removably inserted into the bottom opening of the main body, and
a plurality of evenly spaced divots disposed along the protruding upper surface, each of said divots being configured to receive a tip end of a skewer; and
a cap section that includes
a top surface and a bottom surface,
a generally rectangular cap protrusion secured to the bottom surface, said cap protrusion being configured to be removably inserted into the top opening of the main body, and
a plurality of evenly spaced openings extending from the top surface through the cap protrusions, each of said openings being configured to receive a single skewer.

2. The device of claim 1, further comprising:
an upper lip disposed along an inside periphery of the top opening of the main body, said lip having a dimension that approximates a dimension of the cap protrusion of the cap section.

3. The device of claim 2, further comprising:
a lower lip disposed along an inside periphery of the bottom opening of the main body, said lip having a dimension that approximates a dimension of the protruding upper surface of the base section.

4. The device of claim 3, wherein each of the plurality of elongated groves are bounded at a top end by the upper lip, and at a bottom end by the lower lip.

5. The device of claim 1, wherein each of the main body, cap section and base section are constructed from at least one of a stainless steel, plastic, wood, bamboo and fiberglass.

6. The device of claim 1, wherein each of the plurality of openings of the cap section correspond to one of the plurality of evenly spaced divots positioned within the base section.

7. A method for preparing food items utilizing food preparation device, said method comprising:
loading a plurality of food items into an interior space of a main body, said main body having a plurality of opposing side walls that each contain a plurality of elongated grooves for accessing the interior space;
securing a base section to a bottom opening of the main body, said base section having a plurality of evenly spaced divots located along a top surface thereof;
securing a cap section to a top opening of the main body, said top section including a plurality of evenly spaced openings extending therethrough for accessing the interior space;
inserting one or more skewers through at least one of the evenly spaced openings and the food items;
resting a tip of the one or more skewers into one of the plurality of divots;
inserting a cutting instrument through a pair of elongated grooves located on opposing side walls;
imparting a cutting motion onto the food items;
inserting the cutting instrument through another pair of elongated grooves located on opposing side walls;
imparting another cutting motion onto the food items;
removing the cutting instrument;
removing the cap section from the main body; and
removing the main body from the base section.
